(19) United States
(12) Patent Application Publication
(10) Pub. No.: US 2014/0067630 A1
(43) Pub. Date: Mar. 6, 2014

(54) Real-Time Earned Revenue

(71) Applicants: Brian James Messerich, Sandy, UT (US); Thomas Christopher Trksak, Ham Lake, MN (US)

(72) Inventors: Brian James Messerich, Sandy, UT (US); Thomas Christopher Trksak, Ham Lake, MN (US)

(73) Assignee: ACCENTURE GLOBAL SERVICES LIMITED, Dublin (IE)

(21) Appl. No.: 13/600,895

(22) Filed: Aug. 31, 2012

(51) Int. Cl. G06Q 40/00

(52) U.S. Cl. 705/30

(57) ABSTRACT

Methods, systems, and apparatus, including computer programs encoded on a computer storage medium, for realizing revenue in real-time, the revenue being earned from a travel conveyance. Methods include determining that a travel conveyance status has changed from a first status to a second status, in response to determining that the travel conveyance status has changed, automatically generating a status message, the status message comprising a travel conveyance manifest, and transmitting the status message, receiving, at a computer-implemented accounting service, the status message and in response to receiving the status message, automatically processing the travel conveyance manifest to realize revenue based on one or more bookings associated with the travel conveyance, and updating an accounting associated with the travel conveyance based on realized revenue, the accounting being stored in computer-readable memory.

### BACKGROUND

Travel service providers generate revenue based on passengers traveling on travel conveyances. In some examples, revenue can be generated based on fares, taxes and/or fees paid by passengers. In accounting for revenue, revenue can have a liability status until the revenue is transitioned to an earned status. In some examples, revenue is only deemed to be earned revenue after a travel conveyance is closed. For example, a flight can be determined to be closed after passengers have boarded and the gate agent closes the flight.

In some accounting systems, revenue is processed on a periodic or batch basis at some point after the underlying travel conveyances are closed. In some examples, passenger information for one or more travel conveyances can be retrieved and processed on a periodic basis to determine actually earned revenue from potential revenue. For example, although a passenger was booked for travel on a particular travel conveyance, the passenger might not have actually boarded the travel conveyance. Consequently, whether revenue can be determined to be earned for the absent passenger would not be determined until the passenger information is processed at the next period.

### SUMMARY

Implementations of the present disclosure include computer-implemented methods for realizing revenue in real-time, the revenue being earned from a travel conveyance. Implementations include actions of determining that a travel conveyance status has changed from a first status to a second status, in response to determining that the travel conveyance status has changed, automatically generating a status message, the status message comprising a travel conveyance manifest, and transmitting the status message, receiving, at a computer-implemented accounting service, the status message and in response to receiving the status message, automatically processing the travel conveyance manifest to realize revenue based on one or more bookings associated with the travel conveyance, and updating an accounting associated with the travel conveyance based on realized revenue, the accounting being stored in computer-readable memory.

In some implementations, the first status is a scheduled status and the second status is a closed status.

In some implementations, the travel conveyance manifest provides a record of one or more passengers of the travel conveyance including revenue associated with each passenger.

In some implementations, the revenue associated with each passenger includes one or more of fare, tax and fees.

In some implementations, processing the travel conveyance manifest includes changing revenue from a liability status to an earned status.

In some implementations, the computer-implemented travel service includes a boarding system, the boarding system being operable to change the first status to the second status, and a sink, the sink being responsive to the change.

In some implementations, the sink generates a change message, the change message comprising the travel conveyance manifest.

In some implementations, actions further include providing the accounting to a travel service provider associated with the travel conveyance.

In some implementations, the computer-implemented travel service includes a notification service, the notification service receiving a change message in response to a change in the travel conveyance status.

In some implementations, the notification service includes a protocol handler, the protocol handler generating and transmitting the status message.

In some implementations, a computer-implemented accounting service receives the status message and performs processing of the travel conveyance manifest and updating the accounting.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example system that can execute implementations of the present disclosure.

FIG. 2 depicts example components in accordance with implementations of the present disclosure.

FIG. 3 depicts an example process that can be executed in implementations of the present disclosure.

Like reference symbols in the various drawings indicate like elements.

### DETAILED DESCRIPTION

Implementations of the present disclosure are generally directed to realizing earned revenue from travel conveyances in real-time. More specifically, the present disclosure is directed to implementations of asynchronous, event-driven systems that broker between multiple components to provide real-time accounting of revenue that is earned from travel provided on a travel conveyance. In this manner, revenue can be moved from a liability status to an earned status in real-time in response to closure of the travel conveyance. For example, in response to a closure event, a message can be automatically generated and dispatched to propagate changes resulting from the event to other components to provide the real-time accounting of revenue.

Implementations of the present disclosure are discussed in further detail below with reference to an example context. As provided herein, the example context includes travel in the travel industry. A particular context used for illustration herein includes the airline travel industry. It is appreciated, however, that implementations of the present disclosure can be applicable to other contexts.

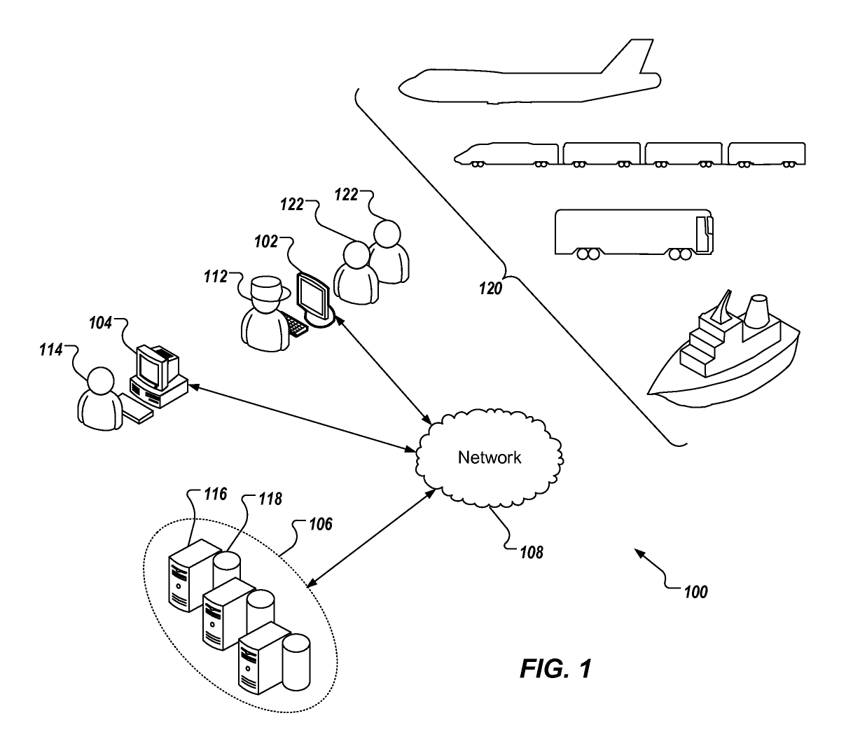

FIG. 1 depicts an example system 100 that can execute implementations of the present disclosure. The example system 100 includes a computing device 102, a computing device 104, a server system 106 and a network 108. The computing devices 102, 104 and the server system 106 can communicate over the network 108. The computing device 102 can be operated by a user 112, and the computing device 104 can be operated by a user 114. The server system 106 can include one or more server computing devices 116 and one or more computer-readable storage devices 118.

In some implementations, the computing devices 102, 104 can be computing devices such as laptop or desktop computers, smartphones, personal digital assistants, portable media players, tablet computers, terminal computers and/or other appropriate computing devices. In some implementations, the computing devices 102, 104 perform client-side operations, as discussed in further detail herein. In some implementations, the server system 106 can include one or more server computing devices such as a computer server. In some implementations, the server system 106 can represent more than one computing device working together to perform the server-side operations, as discussed in further detail herein. In some implementations, the network 108 can be a public communication network (e.g., the Internet, cellular data network, dialup modems over a telephone network) or a private communications network (e.g., private LAN, leased lines).

In some implementations, the example system 100 can be used to book a travel accommodation on a travel conveyance 120, to check-in for travel on the travel conveyance 120 and to board passengers for travel on the travel conveyance 120. Example travel conveyances can include an aircraft, a train, a bus and a ship. In some examples, the server system 108 hosts a booking system that can be used to book a travel accommodation on the travel conveyance 120. In some examples, the server system 108 hosts a check-in system to check passengers in for travel on the travel conveyance 120. In some examples, the server system 108 can host a boarding system for boarding passengers onto the travel conveyance 120 for travel. In some examples, each of the booking system, the check-in system and the boarding system can be provided as one or more computer-executable programs that are executed using the server system 108. In some examples, the booking system, the check-in system and/or the boarding system can be integrated into a single system (e.g., a travel provider system) that provides the booking, check-in and/or boarding functionalities discussed herein. For purposes of non-limiting discussion, the booking system, the check-in system and the boarding system will be collectively referred to herein as the travel provider system, whether integrated into a single system or provided as one or more individual systems.

In some examples, the user 112 can be an agent of a travel service provider and can use the computing device 102 to access the travel provider system to book, check-in and/or board one or more passengers 122 for travel on the travel conveyance 120. In some examples, the user 114 can be a passenger and can use the computing device 104 to access the travel provider system to book and/or check-in for travel on the travel conveyance 120.

In some implementations, the travel provider system can be a web-based system that provides an interface within a general purpose browser executed on a computing device (e.g., the computing devices 102, 104). For example, a user (e.g., the users 112, 114) can access information regarding the dates of travel and travel accommodations available on the travel conveyance and can generate a booking using the web-based system. As another example, the user (e.g., the users 112, 114) can access information regarding a booking and can check-in for travel on the travel conveyance. In some implementations, the travel provider system can be a web-based system that provides a booking interface within a general purpose browser or a booking-specific browser executed on a computing device. Users can access information regarding a potential passenger, the dates of travel and travel accommodations available on the travel conveyance and can generate a booking using the web-based system. In some examples, the agent can be an independent agent (e.g., a travel agent). In some examples, the agent can be an employee of a travel service provider (e.g., an airline).

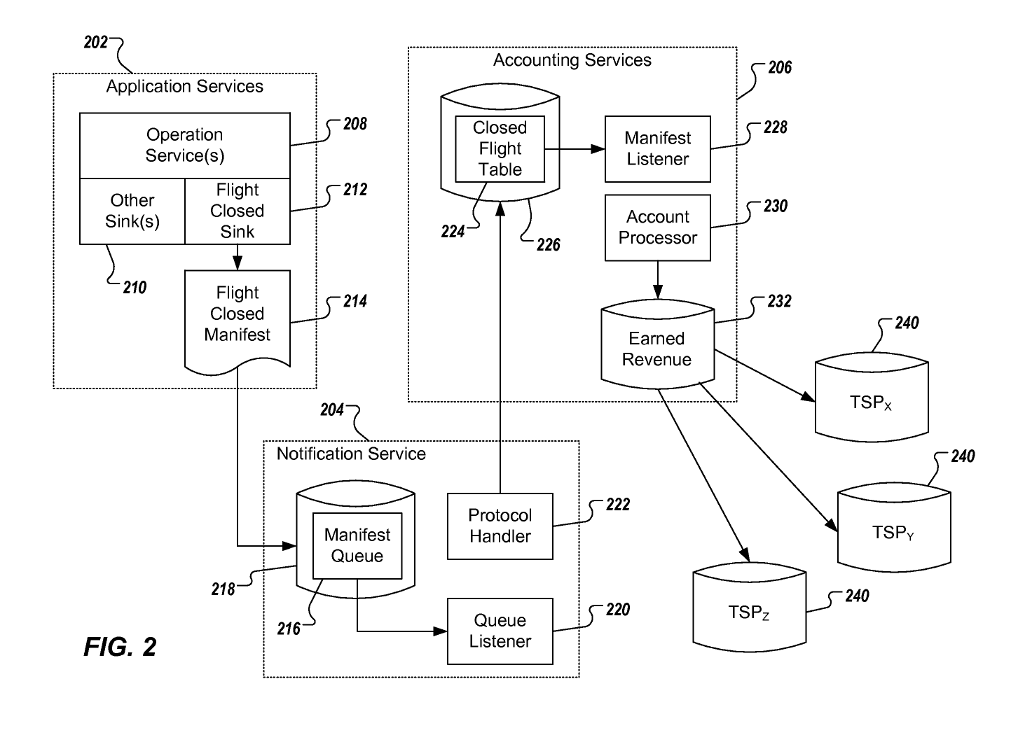

FIG. 2 depicts example components in accordance with implementations of the present disclosure. More specifically, FIG. 2 depicts a real-time earned revenue system 200 including an application services component 202, a notification service component 204 and an accounting services component 206. In some examples, each of the application services component 202, the notification service component 204 and the accounting services component 206 can be provided as one or more computer-executable programs that can be executed using one or more computing devices (e.g., within the server system 108 of FIG. 2).

In some implementations, the application services component 202 can communicate with the notification service component 204, and the notification services component 204 can communicate with the accounting services component 206. In some examples, and as discussed in further detail herein, the application services component 202 can include one or more application services that can be hosted by a third-party service provider. In some examples, and as discussed in further detail herein, the accounting services component 206 can include one or more accounting services that can be hosted at a travel service provider. In some examples, the notification service component 204 can include one or more notification services that can be hosted by the third party service provider and/or at the travel service provider.

As discussed in further detail herein, the real-time earned revenue system 200 enables real-time accounting of revenue that is earned from travel provided on a travel conveyance. In this manner, the revenue can be moved from a liability status to an earned status in real-time in response to closure of the travel conveyance. In some examples, the real-time earned revenue system 200 is an asynchronous, event-driven system that brokers between the multiple components provided therein. For example, in response to an event, an integration component is invoked to propagate changes resulting from the event to other components of the real-time earned revenue system 200.

In accordance with implementations of the present disclosure, real-time describes actions that can be automatically executed, without requiring human input and without any intentional delay, taking into account the processing limitations of the earned revenue system 200 and any time required to process data. More particularly, and in response to an event, the application services component 202 can provide data to the notification services component 204, the notification services component 204 can provide data to the accounting services component 206, and revenue can be marked as earned in real-time.

In some implementations, the application services component 202 can include one or more operation services 208. In some examples, the one or more operation services 208 can include the booking system, the check-in system and/or the boarding system, discussed above. In some examples, each of the operation services 208 communicates with one or more sinks 210, 212. In some examples, a sink can be provided as an integration component that listens for events triggered by the one or more operation services 208. For example, the sink 212 is provided as a flight closed sink that listens for flight closed events (e.g., triggered by the boarding system).

In accordance with implementations of the present disclosure, a flight closed event is triggered in response to passengers having been boarded on the underlying flight and an agent marking the flight as closed. That is, the flight is changed from a scheduled status to a closed status. In some examples, the agent can include a gate agent of the travel service provider (e.g., airline) that uses the boarding system to board the flight and to mark the flight as closed. In response to the flight being marked as closed, the flight closed event is triggered and is recognized by the flight close sink 212. In some examples, the flight closed sink 212 generates a message that includes a flight closed manifest 214. In some examples, the message is provided as a change message (e.g., a delta). In some examples, the flight closed manifest 214 provides a record of all passengers associated with the underlying flight and the status of each passenger (e.g., boarded, not boarded) based on passengers that were booked for the flight. In some examples, the flight closed manifest 214 further provides a record of any additional services or other special circumstances associated with particular passengers. For example, the flight closed manifest 214 can provide a record of the fare and/or taxes paid by a particular passenger, but can also provide a record of special service requests (SSRs) purchased by the passenger. Example SSRs can include preferred seating, extra baggage, over-weight baggage, food/beverage requests and the like.

The message including the flight closed manifest is received at the notification service component 204. In the depicted example, the notification service component 204 includes a manifest queue 216 provided in a computer-readable repository 218, a queue listener 220 and a protocol handler 222. In some examples, the flight closed manifest 214 is persisted to the manifest queue 216. In some examples, the queue listener 220 is responsive to receipt of the flight closed manifest 214 and provides the flight closed manifest 214 to the protocol handler 222. In some examples, the protocol handler 222 processes the flight closed manifest 214 to generate a message that includes a protocol. In some examples, the protocol handler 222 determines the protocol based on the destination of the message. For example, the protocol handler 222 can determine that the message (including the flight closed manifest 214) is to be provided to the accounting services component 206 and can identify an appropriate format for processing of the flight closed manifest 206 at the accounting services component 206 (e.g., a pre-defined table format).

The message from the protocol handler 222 is received at the accounting services component 206. In the depicted example, the accounting services component 206 includes a closed flight table 224 provided in a computer-readable repository 226, a manifest listener 228, and account processor 230 and an earned revenue repository 232. In some examples, the message from the protocol handler 222 is processed and an entry corresponding to the underlying flight closed manifest 214 is input into the closed flight table 224. In some examples, the manifest listener 228 is responsive to new entries in the closed flight table 224. When a new entry is present, the manifest listener 228 triggers the account processor 230. In some examples, the account processor 230 executes an earned revenue accounting event within the accounting services component 206. More particularly, the account processor 230 processes flight information provided in the flight closed manifest 214 to transition revenue generated by the underlying flight to an earned status. In some examples, the accounting processor 230 can process the status of each passenger provided for in the flight closed manifest 214 to realize revenue as earned revenue generated for each passenger (e.g., fares, taxes, SSR fees, etc.). In some examples, the earned revenue can be stored in the earned revenue repository 232.

In some examples, the accounting services component 206 can be located at the travel service provider (TSP). In such examples, the earned revenue repository 232 is specific to the travel service provider. In some examples, the accounting services component 206 can be provided by a third-party service provider. In such examples, the earned revenue information stored within the earned revenue repository 232 can be provided to accounting repositories 240 associated with respective travel service providers (e.g., TSP_{X}, TSP_{Y}, TSP_{Z}). For example, each travel service provider can selectively and/or periodically access the earned revenue repository 232 to retrieve earned revenue information associated with travel services the respective travel service providers have provided.

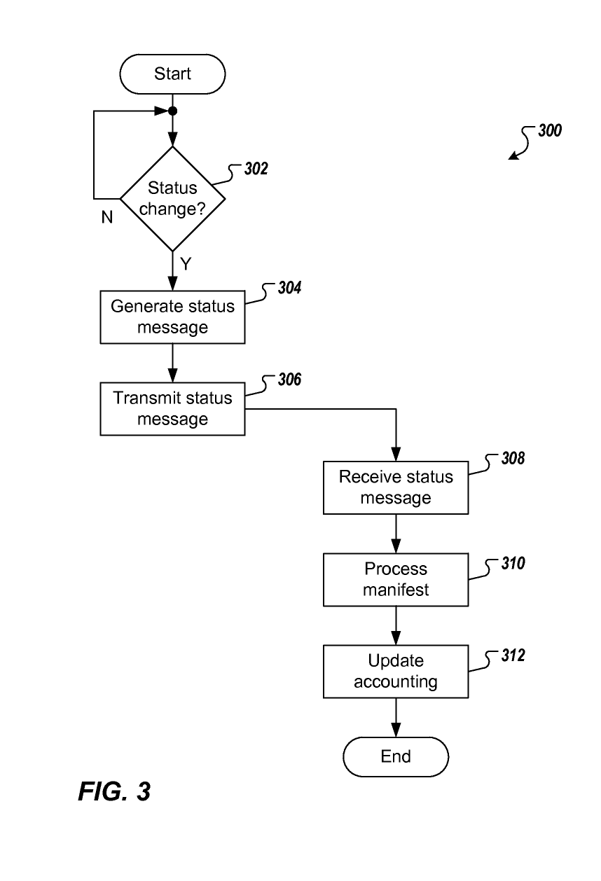

FIG. 3 depicts an example process 300 that can be executed in implementations of the present disclosure. In some examples, the process 300 can be implemented as one or more computer-executable programs that can be executed using one or more computing devices. In some examples, the process 300 is executed automatically. In some examples, the process 300 and/or portions of the process 300 are executed automatically in response to occurrence of an event (e.g., a status change of a travel conveyance).

It is determined whether a status has changed (302). In some examples, it can be determined whether a travel conveyance status has changed from a first status to a second status. For example, a flight can have a first status of scheduled that can be changed to a second status of closed. In some examples, and with reference to FIG. 2, the flight closed sink 212 can determine whether the status has changed and can provide a change message to the notification service component 204. In some examples, the change message includes information associated with the travel conveyance. For example, the change message can include the flight closed manifest 214 of FIG. 2.

A status message is generated (304). For example, the notification service component 204 can generate the status message in response to receiving the change message (e.g., in response to the travel conveyance status changing from the first status to the second status). The status message is transmitted (306). For example, the status message is transmitted from the notification service component 204 to the accounting services component 206. The status message is received (308). For example, the accounting services component 206 receives the status message. A manifest is processed (310). For example, and in response to receiving the status message, the travel conveyance manifest is automatically processed to realize revenue based on one or more bookings associated with the travel conveyance. An accounting associated with the travel conveyance is updated based on realized revenue (312).

In general, implementations of the present disclosure provide travel service providers with real-time information into earned revenue at a travel conveyance level (e.g., flight level). Such real-time information can be consumed by a downstream general ledger (G/L) system. In this manner, real-time reporting of earned fare, tax and/or fee revenue can be available to travel service providers, giving travel service providers up-to-date information on their business.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be realized on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Implementations may be realized in a computing system that includes a back end component, e.g., as a data server, or that includes a middleware component, e.g., an application server, or that includes a front end component, e.g., a client computer having a graphical user interface or a Web browser through which a user may interact with an implementation, or any appropriate combination of one or more such back end, middleware, or front end components. The components of the system may be interconnected by any appropriate form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

Thus, particular implementations have been described. Other implementations are within the scope of the following claims. For example, the actions recited in the claims may be performed in a different order and still achieve desirable results.

What is claimed is:

1. A computer-implemented method for realizing revenue in real-time, the revenue being earned from a travel conveyance, the method being executed using one or more processors and comprising:
determining, using a computer-implemented travel service, that a travel conveyance status has changed from a first status to a second status;
in response to determining that the travel conveyance status has changed to the second status, automatically:
generating a status message, the status message comprising a travel conveyance manifest, and
transmitting the status message,
receiving, at a computer-implemented accounting service, the status message; and
in response to receiving the status message, automatically:
processing the travel conveyance manifest to realize revenue based on one or more bookings associated with the travel conveyance, and
updating an accounting associated with the travel conveyance based on realized revenue, the accounting being stored in computer-readable memory.

2. The method of claim 1, wherein the first status is a scheduled status and the second status is a closed status.

3. The method of claim 1, wherein the travel conveyance manifest provides a record of one or more passengers of the travel conveyance including revenue associated with each passenger.

4. The method of claim 3, wherein the revenue associated with each passenger comprises one or more of fare, tax and fees.

5. The method of claim 1, wherein processing the travel conveyance manifest comprises changing revenue from a liability status to an earned status.

6. The method of claim 1, wherein the computer-implemented travel service comprises a boarding system, the boarding system being operable to change the first status to the second status, and a sink, the sink being responsive to the change.

7. The method of claim 6, wherein the sink generates a change message, the change message comprising the travel conveyance manifest.

8. The method of claim 1, further comprising providing the accounting to a travel service provider associated with the travel conveyance.

9. The method of claim 1, wherein the computer-implemented travel service comprises a notification service, the notification service receiving a change message in response to a change in the travel conveyance status.

10. The method of claim 9, wherein the notification service comprises a protocol handler, the protocol handler generating and transmitting the status message.

11. The method of claim 1, wherein a computer-implemented accounting service receives the status message and performs processing of the travel conveyance manifest and updating the accounting.

12. A non-transitory computer-readable storage medium coupled to one or more processors and having instructions stored thereon which, when executed by the one or more processors, cause the one or more processors to perform operations for realizing revenue in real-time, the revenue being earned from a travel conveyance, the operations comprising:
determining that a travel conveyance status has changed from a first status to a second status;
in response to determining that the travel conveyance status has changed to the second status, automatically:
generating a status message, the status message comprising a travel conveyance manifest, and
transmitting the status message,
receiving, at a computer-implemented accounting service, the status message; and
in response to receiving the status message, automatically:
processing the travel conveyance manifest to realize revenue based on one or more bookings associated with the travel conveyance, and
updating an accounting associated with the travel conveyance based on realized revenue, the accounting being stored in computer-readable memory.

13. A system, comprising:
a computing device; and
a computer-readable storage device coupled to the computing device and having instructions stored thereon which, when executed by the computing device, cause the computing device to perform operations for realizing revenue in real-time, the revenue being earned from a travel conveyance, the operations comprising:
determining that a travel conveyance status has changed from a first status to a second status;
in response to determining that the travel conveyance status has changed to the second status, automatically:
generating a status message, the status message comprising a travel conveyance manifest, and
transmitting the status message,
receiving, at a computer-implemented accounting service, the status message; and
in response to receiving the status message, automatically:
processing the travel conveyance manifest to realize revenue based on one or more bookings associated with the travel conveyance, and
updating an accounting associated with the travel conveyance based on realized revenue, the accounting being stored in computer-readable memory.
